(19) United States
(12) Patent Application Publication
(10) Pub. No.: US 2002/0148816 A1
(43) Pub. Date: Oct. 17, 2002

(54) Method and apparatus for fabricating printed circuit board using atmospheric pressure capillary discharge plasma shower

(76) Inventors: Chang Bo Jung, Seoul (KR); Jong Han Jeong, Seoul (KR); Hyun Jo So, Chungcheongbuk-do (KR); Dong Woo Yu, Demarest, NJ (US); Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(21) Appl. No.: 09/935,047

(22) Filed: Aug. 23, 2001

Related U.S. Application Data
(60) Provisional application No. 60/283,960, filed on Apr. 17, 2001.

(51) Int. Cl. B23K 10/00

(52) U.S. Cl. 219/121.41; 219/121.43; 219/121.59

(57) ABSTRACT

A method and apparatus for treating a workpiece using capillary discharge plasma are disclosed in the present invention. More specifically, a method of desmearing holes in a copper laminated board and forming a conductive material in the holes using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of drilling the copper laminated board to remove at least a portion of the copper laminated board, placing the copper laminated board having the holes in the apparatus, applying a potential to the plasma generator, providing a working gas in close proximity to the copper laminated board, generating capillary discharge plasma out of the capillary, thereby treating the copper laminated board with the atmospheric pressure capillary discharge plasma to remove resin residues in the holes, and forming the conductive material on the copper laminated board including in the holes.

This application claims the benefit of a provisional application, entitled “Method and Apparatus for Fabricating Printed Circuit Board Using Atmospheric Pressure Capillary Discharge Plasma,” which was filed on Apr. 17, 2001, and assigned Provisional Application No. 60/283,960, which is hereby incorporated by reference.

### BACKGROUND OF THE INVENTION

1. Field of the Invention

The present invention relates to a printed circuit board, and more particularly, to a method and apparatus for fabricating a printed circuit board using capillary discharge plasma shower. Although the present invention is suitable for a wide scope of applications, it is particularly suitable for smear treatment, enhancement of Cu layer peel strength, and surface cleaning in fabricating a printed circuit board (PCB) with a relatively low cost.

2. Discussion of the Related Art

Recently, with miniaturization of electronic components, high-density boards have been demanded by the PCB industry. For this, via holes or through holes formed by a laser or mechanical drilling have been required in fabricating a PCB. Drill smear is generated during drilling and covers the surface of the conductive inner layers and remains inside the holes. Thus, it prevents good electrical connection as well as provides poor adhesion with a conductive layer to be formed on the board.

In order to remove drill smear from the board, a harsh acid etching process has been used. While this process gave reasonable etch rates and uniformity, it has major drawbacks. An acid etching process generates large volumes of hazardous wastes. In addition, acid etching is unable to etch polyimide dielectrics.

After forming circuit patterns, the electronic components are cleaned by a harsh chemical method and a mechanical method for wire bonding to remove organic film and contaminants. One of the most common causes of wire bonding failure is contamination at the wire or the land-interface. Most wet processes rely on dilution to remove contaminants from the surface. While this succeeds in removing most of the contamination from the land area, trace amounts of residue are still left on the surface. This effect can be reduced by using multiple rinses, but this scheme generates an even higher volume of waste, creating additional disposal expenses.

In an effort to overcome the above-discussed chemical method, a dry cleaning method such as plasma has been proposed to remove contaminants without leaving residues. During the plasma process, hydrocarbon contaminants are cracked in volatile products, such as water and carbon dioxide. However, since the conventional plasma processes should operate in a vacuum environment, it requires expensive vacuum systems and components. As a result, the conventional plasma processing is still an expensive process in fabricating a PCB.

### SUMMARY OF THE INVENTION

The present invention is directed to a method and apparatus for fabricating a printed circuit board using capillary discharge plasma shower that substantially obviate one or more of problems due to limitations and disadvantages of the related art.

Another object of the present invention is to provide a method and apparatus for fabricating a printed circuit board using capillary discharge plasma shower for effectively removing drill smear from through holes and micro via holes in the printed circuit board.

Another object of the present invention is to provide a method and apparatus for fabricating a printed circuit board using capillary discharge plasma shower for improving wire bonding yields and strength to the printed circuit board.

Another object of the present invention is to provide a method apparatus for fabricating a printed circuit board using capillary discharge plasma shower for improving Cu layer peel strength of the printed circuit board.

A further object of the present invention is to provide a method and apparatus for fabricating a printed circuit board using capillary discharge plasma shower for improving solder mask adhesion.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the present invention, as embodied and broadly described herein, a method of fabricating a printed circuit board for desmearing holes in a copper laminated board and forming a conductive material in the holes using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of drilling the copper laminated board to remove at least a portion of the copper laminated board, placing the copper laminated board having the holes in the apparatus, applying a potential to the plasma generator, providing a working gas in close proximity to the copper laminated board, generating capillary discharge plasma out of the capillary, thereby treating the copper laminated board with the atmospheric pressure capillary discharge plasma to remove resin residues in the holes, and forming the conductive material on the copper laminated board including in the holes.

In another aspect of the present invention, a method of fabricating a printed circuit board for forming a solder mask on a copper laminated board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of forming a circuit pattern on the copper laminated board, placing the copper laminated board in the apparatus, applying a potential to the plasma generator, providing a working gas in close proximity to the copper laminated board, generating capillary discharge plasma out of the capillary, thereby treating the copper laminated board with the atmospheric pressure capillary discharge plasma, forming a solder mask material on the treated copper laminated board including the circuit pattern, and curing the solder mask material to form a solder mask on the copper laminated board.

In another aspect of the present invention, a method of fabricating a printed circuit board for forming a circuit pattern on a copper laminated board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of pre-treating the copper laminated board, laminating a dry film resist on the pretreated copper laminated board, patterning the dry film resist on the copper laminated board, selectively removing a copper on the copper laminated board using the patterned dry film resist as a mask, stripping the patterned dry film resist from the copper laminated board, placing the copper laminated board in the apparatus, applying a potential to the plasma generator, providing a working gas in close proximity to the copper laminated board, and generating capillary discharge plasma out of the capillary, thereby treating the copper laminated board with the atmospheric pressure capillary discharge plasma to remove residues of the dry film resist on the copper laminated board.

In another aspect of the present invention, a method of fabricating a printed circuit board for wire bonding to a printed circuit board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of plating a conductive layer on the printed circuit board, processing a surface of the conductive layer as desired, cleaning the processed conductive layer, placing the copper laminated board in the apparatus, applying a potential to the plasma generator, providing a working gas in close proximity to the copper laminated board, generating capillary discharge plasma out of the capillary, thereby treating the conductive layer with the atmospheric pressure capillary discharge plasma to remove contaminants on the surface the conductive layer, and bonding a wire or a solder ball to the treated conductive layer.

In a further aspect of the present invention, an apparatus for fabricating a printed circuit board using atmospheric pressure capillary discharge plasma shower includes a loading unit for loading and transferring the printed circuit board, a process unit for treating the printed circuit board including at least one atmospheric plasma generator having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, a display unit for displaying working conditions of the apparatus, and an unloading unit for transferring the treated printed circuit board.

It is to be understood that both the foregoing general description and the following detailed description are exemplary and explanatory and are needed to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B are schematic views of an atmospheric pressure capillary discharge plasma system for plasma treatment in the present invention;

FIG. 1C is a schematic view of a plasma generator of FIGS. 1A and 1B;

FIGS. 2A to 2E are schematic cross-sectional views illustrating process steps of fabrication a printed circuit board for desmearing holes in a copper laminated board and forming a conductive material in the holes using an atmospheric pressure capillary discharge plasma shower according to a first embodiment of the present invention;

FIG. 3 is a graph illustrating roughness and peel strength to compare the effect of the present invention to various conventional methods;

FIGS. 4A to 4D are schematic cross-sectional views illustrating process steps of fabrication a printed circuit board for forming a solder mask on a copper laminated board using an atmospheric pressure capillary discharge plasma shower according to a second embodiment of the present invention;

FIGS. 5A to 5E are schematic cross-sectional views illustrating process steps of fabrication a printed circuit board for forming a circuit pattern on a copper laminated board using an atmospheric pressure capillary discharge plasma shower according to a third embodiment of the present invention; and

FIGS. 6A to 6E are schematic cross-sectional views illustrating process steps of fabrication a printed circuit board for wire bonding to the printed circuit board using an atmospheric pressure capillary discharge plasma shower according to a fourth embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

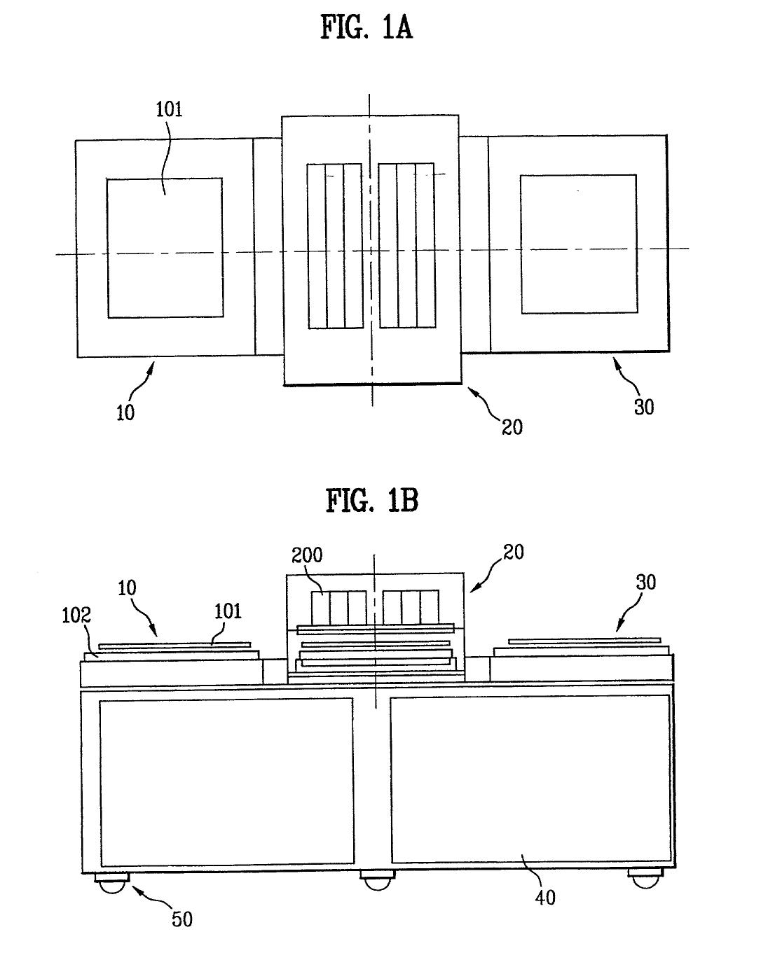

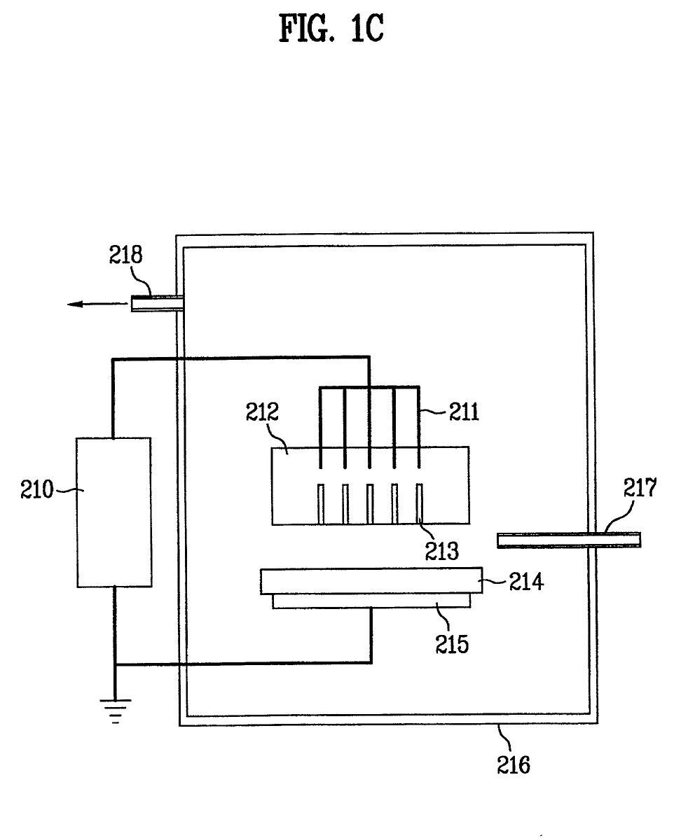

FIGS. 1A and 1B are a plane view and a side view of an atmospheric pressure capillary discharge plasma system of the present invention, respectively. As shown in FIGS. 1A and 1B, the atmospheric pressure capillary discharge plasma system includes a loading unit 10, a processing unit 20, an unloading unit 30, a display unit 40, and a system transfer mechanism 50.

An untreated printed circuit board 101 (PCB) is loaded in the loading unit 10 and transferred to the process unit 20 by a linear moving mechanism 102, such as a conveyor belt or a roller. The process unit 20 includes a plasma generator 200 comprising a plurality of plasma heads treating a PCB in a linear motion. A working gas and a reaction enhancing gas may be provided to the process unit 20. The treated PCB moves forward to the unloading unit 30 for further processes. Since the system can be adopted to the existing manufacturing lines, it can be easily realized as an in-line process.

A schematic cross-sectional view of a unit plasma generator head 200 of the process unit 20 is shown in FIG. 1C. As shown in FIG. 1C, the plasma generator head 200 includes a power supply 210, a first electrode 211 having a pin shape, a dielectric body 212, capillaries 213 formed in the dielectric body 212, a printed circuit board 214, and a counter electrode 215 electrically coupled to the first electrode 211.

One of the terminals of the power supply 210 is coupled to the first electrode 211, while the other terminal is coupled to the counter electrode 215 and is grounded. The dielectric body 212 has first and second sides, the first side coupled to the first electrode 211, and the second side having at least one capillary that extends into a portion of the dielectric body 212.

The first electrode 211 and the capillaries 213 are substantially aligned and generally have a one to one correspondence. Although there are no critical limitation in a thickness of the dielectric body 212, the thickness of the dielectric body 212 may be preferably in the range of 1 mm to 3 cm. A diameter of each capillary is preferably in the range of 50 μm to 8 mm. A PCB is placed between the first electrode 211 and the counter electrode 215 connected to the power supply 210 and subjected to a plasma treatment using capillary discharge plasma.

As illustrated in FIG. 1C, a portion of the dielectric body 212 separates the capillaries from the first electrode 211, thereby preventing a glow-to-arc transition in treating the conducting portion of the PCB. The plasma generator head 200 is housed in a gas chamber 216. The gas chamber 216 has at least two openings 217 and 218, which allow gases to be inserted and removed from the chamber.

Any type of gas or gases may be inserted into the chamber such as Ar, He, O₂, CF₄, H₂ and air or any mixture of Ar, He, O₂, CF₄, H₂ and air. Although any gases can be inserted and removed from the chamber, it is not necessary to create vacuum in the chamber 216 to treat the PCB 214 because the apparatus utilizes high efficiency capillary discharge plasma. Thus, expensive vacuum equipment is not required in this system.

The display unit 40 displays the current operational conditions and electronics. For transferring the whole system to the manufacturing line, the system transfer mechanism 50 such as a roller is attached to the bottom of the system.

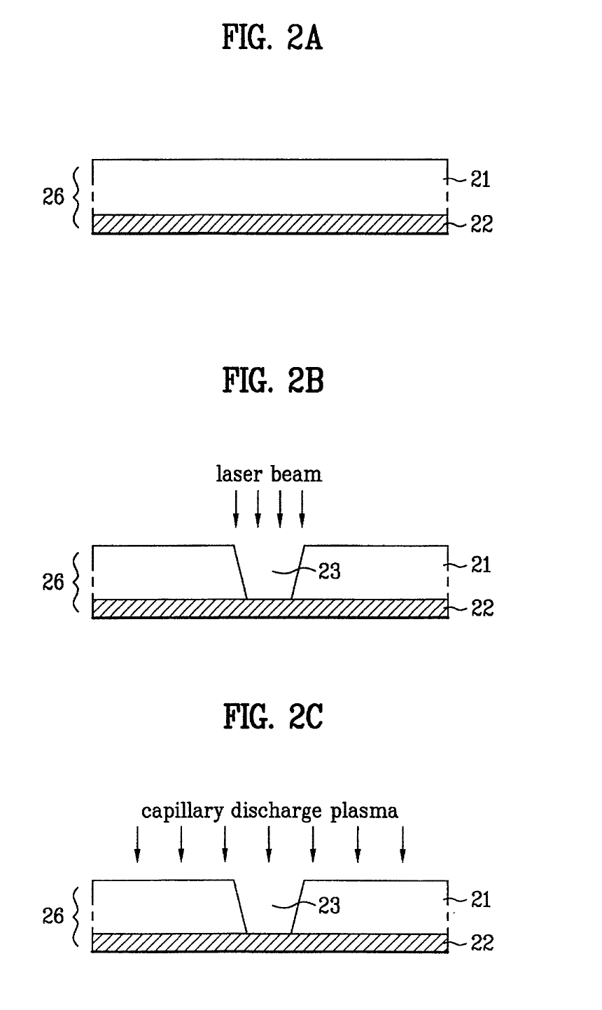

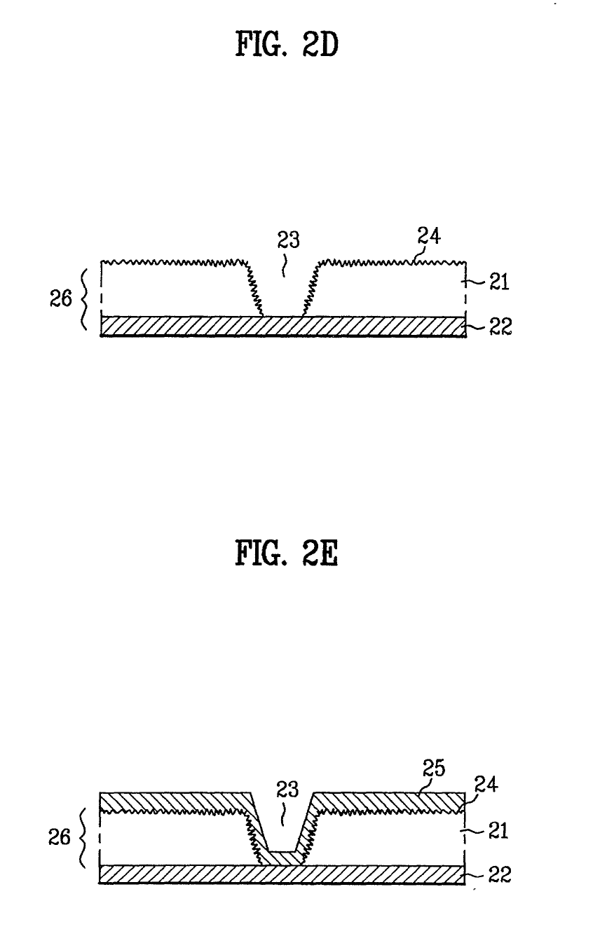

FIGS. 2A to 2E illustrate process steps of desmearing holes in a copper laminated board and forming a conductive material in the holes using an atmospheric pressure capillary discharge plasma apparatus according to the present invention.

Initially referring to FIG. 2A, an individual resin layer 21 is laminated to form a copper laminated board having a copper layer 22 thereon. In FIG. 2B, the copper laminated board is drilled by using a laser to form a via hole 23 or a through hole (not shown).

The copper laminated board is then treated by capillary discharge plasma generated from the plasma generator (shown as the reference numeral 200 in FIGS. 1A to 1C), as shown in FIG. 2C. In this process, an applied potential to the plasma generator is in the range of about 0.5 and 5 kW. The applied potential also has a frequency in the range of about 1 and 500 kHz.

A working gas other than air may be used for a desired result. For example, one of Ar, He, O₂, H₂ or any mixture of these gases may be used. The mixture of the gases includes 30 to 60% Ar, 30 to 60% O₂, 5-30% H₂, and 5 to 30% He. Further, an additional gas, such as 5 to 30% CF₄, may be simultaneously provided for enhancing a reaction. During the capillary plasma treatment, the surface of the PCB is modified by an Ar bombardment as well as a chemical reaction between the oxygen radicals and CF₄ and the resin generating CO₂, CO, and HF. Thus, the treatment removes drill smear and increases a surface roughness as well.

A roughened surface 24 is formed on the laminated copper board 26, as shown in FIG. 2D after the treatment with the capillary discharge plasma. In FIG. 2E, copper is plated by using electroless and electrolytic plating methods on the overall surface including in the via holes. In the electroless plating, a thin copper layer 25 is initially deposited on the surface including in the via holes. Thereafter, a copper layer having a desired thickness is further formed on the electroless plated copper layer.

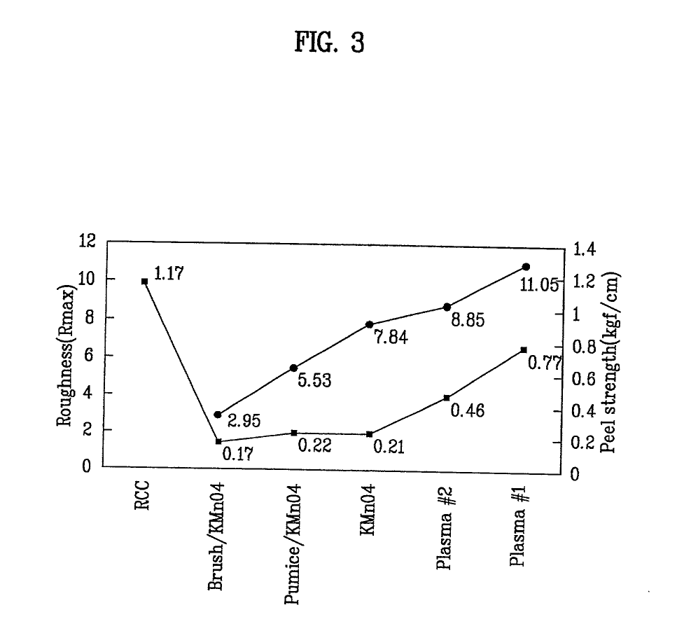

FIG. 3 is a graph illustrating values of peel strengths obtained for various pretreatment methods including the present invention. For example, the peel strengths for the samples treated by the capillary discharge plasma are about 0.46 and 0.77 Kgf/cm, respectively. Roughness (Rmax) of the surfaces for the treated samples are 11.05 and 8.85 μm. Thus, as clearly shown in the graph, the capillary discharge plasma treatment method results in peel strength higher than those of the conventional pre-treatments.

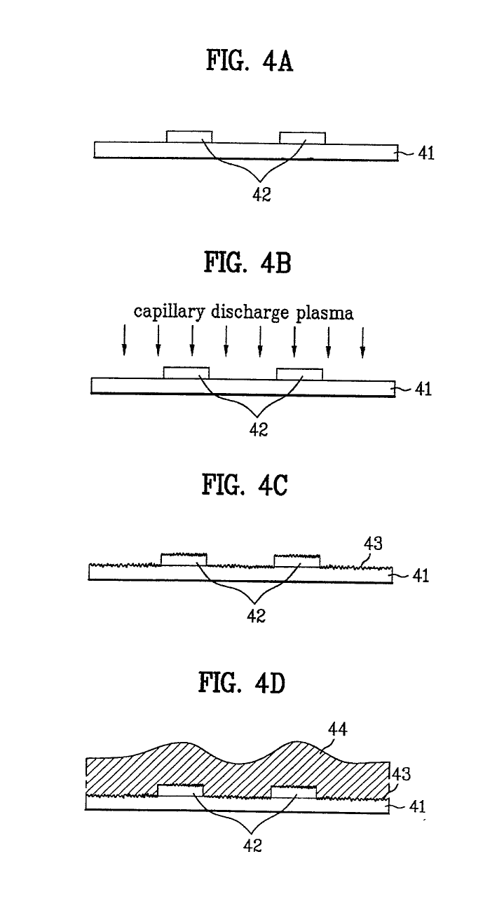

FIGS. 4A to 4D are schematic cross-sectional views illustrating process steps of fabricating a printed circuit board using an atmospheric pressure plasma forming a solder mask on a copper laminated board using an atmospheric pressure capillary discharge plasma apparatus according to a second embodiment of the present invention.

A circuit pattern 42 is formed on a laminated resin board 41 in FIG. 4A. The laminated resin board 41 is treated by capillary discharge plasma, thereby generating a surface roughness 43 on the overall surface, as shown in FIGS. 4B and 4C. Thereafter, a solder mask is formed on the overall surface including the patterned circuit 42.

In the capillary discharge plasma treatment, an applied potential to the plasma generator is in the range of about 0.5 and 5 kW. The applied potential also has a frequency in the range of about 1 and 500 kHz.

Similar to the first embodiment, a working gas other than air may be used for a desired result. For example, one of Ar, He, CF₄, H₂, and O₂ or any mixture of these gases may be used. The mixture of the gases includes 30 to 60% Ar, 30 to 60% O₂, 5 to 30% He, and 5 to 30% CF₄. Further, an additional gas, such as 0 to 30% H₂, may be simultaneously provided for enhancing a reaction. During the capillary plasma treatment, the surface of the PCB is modified by an Ar bombardment as well as a chemical reaction between the oxygen radicals and CF₄ and the resin generating CO₂, CO, and HF. Thus, the treatment increases a surface roughness, thereby substantially improving adhesion between the solder mask and the resin board.

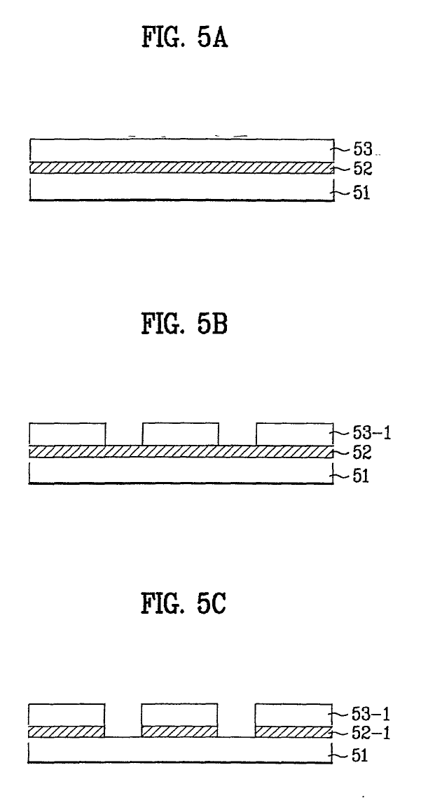

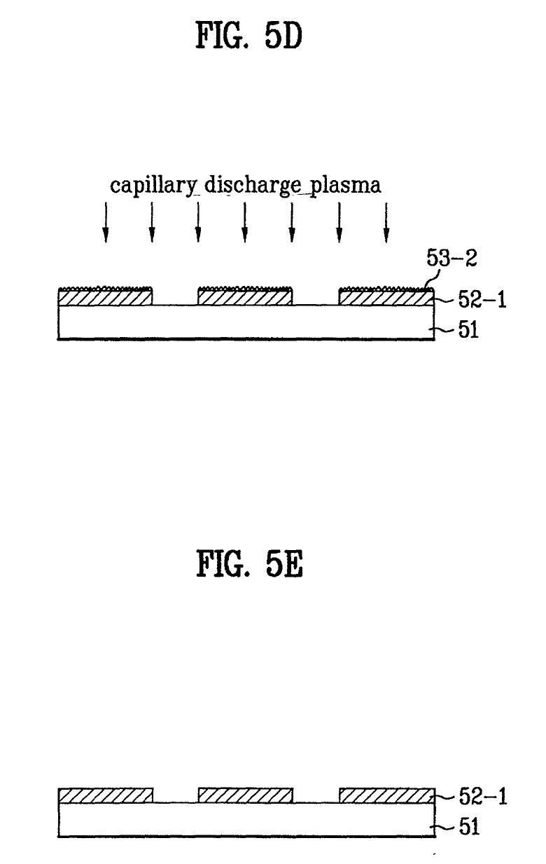

FIGS. 5A to 5E are schematic cross-sectional views illustrating process steps of fabricating a printed circuit board for forming a circuit pattern on a copper laminated board using an atmospheric pressure capillary discharge plasma shower according to a third embodiment of the present invention.

In FIG. 5A, a copper laminated board 51 having a copper layer 52 thereon is pre-treated by a chemical or mechanical method. A dry film resist (DFR) 53 is laminated on the copper laminated board 51. The dry film resist 53 is patterned to have a desired pattern 53-1 thereon, as shown in FIG. 5B. Using the pattern 53-1 as a mask, the copper layer 52 is selectively removed to have a circuit pattern 52-1 in FIG. SC. The dry film resist pattern 53-1 is stripped off from the patterned copper layer 52-1. However, even after removing the patterned copper layer 52-1, some residues 53-2 remain on the surface of the copper laminated layer 52-1, as shown in FIG. 5D.

In order to completely remove the residues 53-2 on the patterned copper layer 52-1, the copper laminated board including the copper laminated layer 52-1 is treated by an atmospheric pressure capillary discharge plasma as shown in FIG. 5D. After the plasma treatment, the dry film resist residues are completely removed from the patterned copper layer 52-1, as shown in FIG. 5E.

Operation conditions in the third embodiment are similar to the previous embodiments. Thus, detailed descriptions are omitted for simplicity.

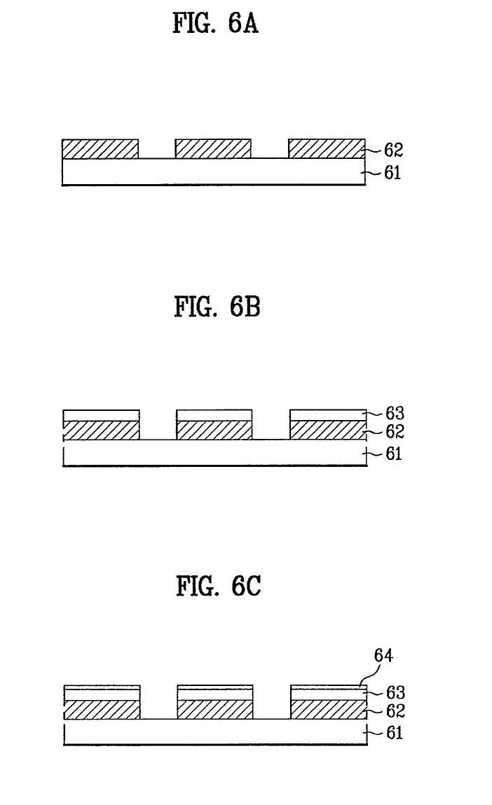

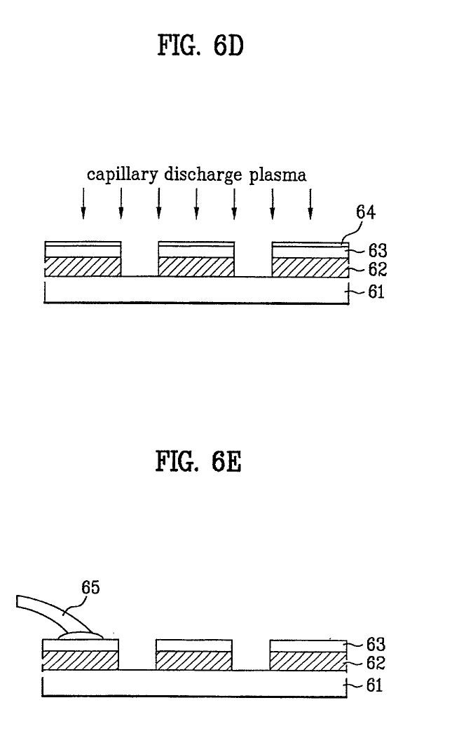

FIGS. 6A to 6E are schematic cross-sectional views illustrating process steps of fabricating a printed circuit board for wire bonding to the printed circuit board using an atmospheric pressure capillary discharge plasma shower according to a fourth embodiment of the present invention.

Initially referring to FIG. 6A, a copper laminated board 61 has a patterned circuit layer 62 thereon. A conductive layer 63 such as Ni/Au layer is plated on the patterned circuit layer 62, as shown in FIG. 6B. After processing the exterior surface of the conductive layer 63 for a desired condition, the copper laminated layer 63 is cleaned by water and dried. However, contamination and an inorganic/organic compound 64 are formed on the conductive surface during the final PCB process including the water cleaning, as shown in FIG. 6C.

Therefore, an atmospheric pressure capillary discharge plasma shower is used to remove the contamination and the inorganic/organic compound prior to a wire bonding process as shown in FIG. 6D. Poor bond strength and low bonding yields are often a result of contamination on the bonding land, such as a Ni/Au plated layer. The capillary discharge plasma process is highly effective in improving wire bonding yields and pull strengths without leaving any contaminants on the bonding land.

Operation conditions in the fourth embodiment are similar to the previous embodiments except for the-working gas and the reaction gas. In this embodiment, the working gas includes one of Ar, He, O₂, H₂, and air, and any mixture of Ar, He, H₂, O₂, and air. More specifically, when a mixture gas is used, 30 to 60% Ar, 30 to 60% O₂, and 5 to 30% He is preferable. Also, it is preferable to use reaction-enhancing gases of 5 to 30%H₂ and 5 to 30% CF₄.

Finally, a solder ball or a wire is attached to the conductive layer, thereby completing the PCB fabrication process, as shown in FIG. 6E.

The above-mentioned effects of the capillary discharge plasma treatment are due to unique characteristics of an atmospheric pressure capillary plasma such as high-density plasma, low temperature and higher energy efficiency as compared to the conventional ac barrier plasma and corona discharges. Additionally, the atmospheric pressure capillary plasma system provides good uniformity, low cost and the possibility of inline process because an expensive vacuum system is not required. Furthermore, the system can also be used in either batch or continuous mode, and hence achieve high yield.

It will be apparent to those skilled in the art that various modifications and variations can be made in the method and apparatus for treatment using atmospheric pressure capillary plasma of the present invention without departing from the scope or spirit of the invention. Thus, it is intended that the present invention covers the modifications and variations of this invention provided they come within the scope of the appended claims and their equivalents.

What is claimed is:

1. A method of fabricating a printed circuit board for desmearing holes in a copper laminated board and forming a conductive material in the holes using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of:
drilling the copper laminated board to remove at least a portion of the copper laminated board;
placing the copper laminated board having the holes in the apparatus;
applying a potential to the plasma generator;
providing a working gas in close proximity to the copper laminated board;
generating capillary discharge plasma out of the capillary, thereby treating the copper laminated board with the atmospheric pressure capillary discharge plasma to remove resin residues in the holes; and
forming the conductive material on the copper laminated board including in the holes.

2. The method according to claim 1, wherein the applied potential is in the range of about 0.5 and 5 kW.

3. The method according to claim 1, wherein the applied potential has a frequency in the range of about 1 and 500 kHz.

4. The method according to claim 1, wherein the working gas includes one of Ar, He, O₂, and air, and any mixture of Ar, He, O₂, and air.

5. The method according to claim 4, wherein the any mixture includes 30 to 60% Ar, 30 to 60% O₂, and 5 to 30% He.

6. The method according to claim 1, further comprising the step of simultaneously providing a reaction enhancing gas with the working gas.

7. The method according to claim 6, wherein the reaction enhancing gas includes 5 to 30% CF₄.

8. The method according to claim 6, wherein the step of drilling the copper laminated board forms either via holes or through holes in the board.

9. The method according to claim 1, wherein the step of drilling the copper laminated board includes one of a laser drilling and a mechanical drilling.

10. A method of fabricating a printed circuit board for forming a solder mask on a copper laminated board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of:
forming a circuit pattern on the copper laminated board;
placing the copper laminated board in the apparatus;
applying a potential to the plasma generator;
providing a working gas in close proximity to the copper laminated board;
generating capillary discharge plasma out of the capillary, thereby treating the copper laminated board with the atmospheric pressure capillary discharge plasma;
forming a solder mask material on the treated copper laminated board including the circuit pattern; and
curing the solder mask material to form a solder mask on the copper laminated board.

11. The method according to claim 10, wherein the applied potential is in the range of about 0.5 and 5 kW.

12. The method according to claim 10, wherein the applied potential has a frequency in the range of about 1 to 500 kHz.

13. The method according to claim 9, wherein the working gas includes one of Ar, He, O₂, CF₄, H₂, and air, and any mixture of Ar, He, O₂, H₂, CF₄, and air.

14. The method according to claim 13, wherein one of the mixture includes 30 to 60% Ar, 30 to 60% O₂, 5 to 30% CF₄, and 5 to 30% He.

15. The method according to claim 13, further comprising the step of simultaneously providing a reaction enhancing gas with the working gas.

16. The method according to claim 15, wherein the reaction enhancing gas includes 0 to 30% H₂.

17. A method of fabricating a printed circuit board for forming a circuit pattern on a copper laminated board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of:
pre-treating the copper laminated board;
laminating a dry film resist on the pretreated copper laminated board;
patterning the dry film resist on the copper laminated board;
selectively removing a copper on the copper laminated board using the patterned dry film resist as a mask;
stripping the patterned dry film resist from the copper laminated board;
placing the copper laminated board in the apparatus;
applying a potential to the plasma-generator;
providing a working gas in close proximity to the copper laminated board; and
generating capillary discharge plasma out of the capillary, thereby treating the copper laminated board with the atmospheric pressure capillary discharge plasma to remove residues of the dry film resist on the copper laminated board.

18. The method according to claim 17, wherein the applied potential has a power in the range of about 0.5 and 5 kW.

19. The method according to claim 17, wherein the applied potential has a frequency in the range of about 1 to 500 kHz.

20. The method according to claim 17, wherein the working gas includes one of Ar, He, O₂, CF₄, H₂, and air, and any mixture of Ar, He, O₂, CF₄, H₂, and air.

21. The method according to claim 20, wherein one of the mixture includes 30 to 60% Ar, 30 to 60% O₂, 5 to 30% CF₄, and 5 to 30% He.

22. The method according to claim 17, further comprising the step of simultaneously providing a reaction enhancing gas with the working gas.

23. The method according to claim 17, wherein the reaction enhancing gas includes 0 to 30% H₂.

24. A method of fabricating a printed circuit board for wire bonding to the printed circuit board using an atmospheric pressure capillary discharge plasma apparatus having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode, the method comprising the steps of:
plating a conductive layer on the printed circuit board;
processing a surface of the conductive layer as desired;
cleaning the processed conductive layer;
placing the copper laminated board in the apparatus;
applying a potential to the plasma generator;
providing a working gas in close proximity to the copper laminated board;
generating capillary discharge plasma out of the capillary, thereby treating the conductive layer with the atmospheric pressure capillary discharge plasma to remove contaminants on the surface the conductive layer; and
bonding a wire or a solder ball to the treated conductive layer.

25. The method according to claim 24, wherein the applied potential is in the range of about 0.5 and 5 kW.

26. The method according to claim 24, wherein the applied potential has a frequency in the range of about 1 to 500 kHz.

27. The method according to claim 24, wherein the working gas includes one of Ar, He, O₂, H₂, and air, and any mixture of Ar, He, O₂, H₂, and air.

28. The method according to claim 27, wherein one of the mixture includes 30 to 60% Ar, 30 to 60% O₂, and 5 to 30% He.

29. The method according to claim 24, further comprising the step of simultaneously providing a reaction enhancing gas with the working gas.

30. The method according to claim 29, wherein the reaction enhancing gas includes 5 to 30% H₂ and 5 to 30% CF₄.

31. The method according to claim 24, wherein the conductive layer includes a Ni/Au layer.

32. An apparatus for fabricating a printed circuit board using atmospheric pressure capillary discharge plasma shower, comprising:
a loading unit for loading and transferring the printed circuit board;
a process unit for treating the printed circuit board including at least one atmospheric plasma generator having at least one first electrode receiving a power source, a dielectric body having first and second sides, the first side coupled to the first electrode and the second side having at least one capillary extending to a direction of the first side of the dielectric body, and each capillary substantially aligned with each electrode, and a second electrode electrically coupled to the first electrode;
a display unit for displaying working conditions of the apparatus; and
an unloading unit for transferring the treated printed circuit board.

33. The apparatus according to claim 32, further comprising a working gas source for providing a working gas with the process unit.

34. The apparatus according to claim 32, further comprising a transferring mechanism for transferring the apparatus to a desired position.
